(19) United States
(12) Patent Application Publication
(10) Pub. No.: US 2016/0328418 A1
(43) Pub. Date: Nov. 10, 2016

(54) DATA PROCESSING SYSTEM UTILIZING GEOGRAPHIC INFORMATION AND DATA PROCESSING PROGRAM

(71) Applicant: WINGARC1ST INC., Tokyo (JP)

(72) Inventor: Ko Shimazawa, Tokyo (JP)

(21) Appl. No.: 15/029,428

(22) PCT Filed: Aug. 17, 2015
(86) PCT No.: PCT/JP2015/072998

§ 371 Date: Apr. 14, 2016

(30) Foreign Application Priority Data
Nov. 26, 2014 (JP) 2014-238306

(51) Int. Cl. G06F 17/30

(52) U.S. Cl. CPC G06F 17/30241; G06F 17/30554

(57) ABSTRACT

There are provided an area designating unit 3 for designating a desirable area on a map in a state in which data stored in a first database 11 including geographic information is visualized on the map, an association item designating unit 4 for designating association of an optional data item included in the first database 11 and an optional data item included in a second database 12, and a data retrieving unit 5 for extracting, from the first database 11, data of a data item designated as an association source item in data sets linked to the geographic information associated with the designated area, retrieving the second database 12 with, as a target, a data item designated for an association destination item by using the extracted data as a retrieval key, and extracting data sets which are coincident with the retrieval key.

### TECHNICAL FIELD

The present invention relates to a data processing system utilizing geographic information and a data processing program and more particularly is suitably used for a system for processing data linked to geographic information constituted by an address, a latitude and longitude, the other map coordinates or the like.

### BACKGROUND ART

In recent years, attention is paid to visualization software for analyzing a lot of data and indicating a result of the analysis so as to be understood visually and easily. As one of the visualization software, there is offered a tool which is referred to as a geographic information system (GIS) capable of visualizing numerical data on a map. By using the geographic information system, for example, it is possible to aggregate numerical data for individual regions such as prefectures or municipalities and to display a result of the aggregation on maps separated by color for the respective regions. Moreover, it is also possible to analyze numerical data on clients or sales for each region and to visualize, on a map, a geographic trend or pattern or the like related to business.

In addition, it is also possible to designate an area on a map and to retrieve and aggregate data included in the area based on an attribute (for example, see Patent Documents 1 and 2). Referring to the aggregating server described in the Patent Document 1, when designation of an area on a map is accepted from a client terminal transmitting a request for aggregation, investigation information related to a specific item in the accepted area is aggregated based on contents stored in investigation result storing means and a result of the aggregation is transmitted to the client terminal transmitting the request for the aggregation.

Referring to the map information retrieving and aggregating system described in the Patent Document 2, moreover, a map image within a designated range, and an attribute information item associated with map graphic information related to the map image are transmitted from a server to a client terminal. The client performs area designation for the transmitted map through a mouse and sets the other retrieval and aggregation conditions to give a processing request to the server. The server fetches necessary data from a data server, performs retrieval and aggregation processing for the request and replies to the client terminal. Consequently, a map indicative of a range where retrieval and aggregation are designated and a table of a result obtained by the retrieval and aggregation processing are displayed on the client terminal.

Patent Document 1: Japanese Patent No. 3407805

Patent Document 2: Japanese Laid-Open Patent Publication No. 2003-316808

### DISCLOSURE OF THE INVENTION

According to the technologies described in the Patent Documents 1 and 2, when a user designates a desirable area on a map, data included in the area or any of the data which is included in the area and satisfies designating conditions can be retrieved and aggregated and a result thereof can be visualized and displayed.

In all of these prior arts, however, a single database having geographic information and the other various data as data items is set to be a processing target and various data linked to geographic information associated with the area designated on the map are thus retrieved and aggregated, and a data source is restricted to the single database. For this reason, there is a problem in that it is impossible to retrieve and aggregate data utilizing the geographic information by associating a plurality of databases serving as the processing targets.

In companies, generally, management is often performed with plural types of databases possessed in accordance with applications, for example, a client management database, a product database, a sales management database and a stock management database. Referring to the prior arts, however, only one database is set to be the processing target, for example, only a client management database is set to be a processing target when the client management database should be set to be the processing target. For this reason, the retrieval and aggregation can be performed within only a range of data stored in the single database. For instance, when the client management database is set to be the processing target, various data (for example, business card description information about a client) linked to geographic information (for example, an address of the client) associated with an area designated on a map can only be retrieved or aggregated from the client management database.

In case of a database having, as a data item, geographic information such as an address, for example, the client management database, moreover, the information can be visualized and displayed, on the map, as a GIS processing target and the various data included in the area designated on the map can also be retrieved and aggregated. However, a database having no geographic information as the data item, for example, a product database or a sales management database cannot be set to be the GIS processing target in the first place and the data associated with the area designated on the map can be neither retrieved nor aggregated.

The present invention has been made to solve the problems and has an object to enable retrieval and aggregation of data utilizing geographic information to be flexibly performed beyond a range of data included in a single database. Moreover, it is an object of the present invention to enable execution of retrieval and aggregation of data associated with an area designated on a map for also a database having no geographic information as a data item.

In order to attain the objects, in the present invention, a desirable area on a map is designated in a state in which data included in a first database having geographic information as a data item or a calculation result for the data is visualized and displayed on the map based on the geographic information. Moreover, an optional data item included in the first database is designated as an association source item and an optional data item included in a second database is designated as an association destination item. Then, data of the data item designated as the association source item in data sets linked to the geographic information associated with a designated area is extracted from the first database, the second database is retrieved with, as a target, the data item designated for the association destination item by using the extracted data for a retrieval key and the data sets including the retrieval key in the data of the association destination item are extracted from the second database.

In another mode of the present invention, aggregation is performed by a designated method with, as a target, the data sets extracted from the second database as described above.

According to the present invention having the structure described above, the data associated with the area designated on the map is extracted from the first database by utilizing the geographic information included in the first database, and furthermore, the second database is retrieved with the extracted data as a retrieval key so that data sets corresponding to a condition of the retrieval key are extracted. According to the present invention, thus, it is possible to retrieve and aggregate the data included in the second database beyond a range of the data included in the first database by utilizing the geographic information possessed by the first database. Herein, the second database is retrieved with, as a retrieval key, the data extracted from the first database (which is not restricted to the geographic information). For this reason, it is not essential that the geographic information is included as the data item in the second database.

From the foregoing, according to the present invention, it is possible to flexibly retrieve and aggregate data utilizing geographic information beyond a range of data included in a single database. According to the present invention, moreover, it is possible to retrieve and aggregate data associated with an area designated on a map for also a database having no geographic information as a data item.

### BRIEF DESCRIPTION OF THE DRAWINGS

FIG. 1 is a block diagram showing an example of a structure of a data processing system utilizing geographic information according to the present embodiment.

FIG. 2 is a view showing an example of a screen to be displayed by a visualizing unit according to the present embodiment.

FIG. 3 is a table showing an example of a first database according to the present embodiment.

FIG. 4 is a table showing an example of a second database according to the present embodiment.

FIG. 5 is a view showing an example of a relation setting screen according to the present embodiment.

FIG. 6 is a view showing an example of a screen to be offered by the data processing system according to the present embodiment.

FIG. 7 is a block diagram showing another example of the structure of the data processing system utilizing the geographic information according to the present embodiment.

### BEST MODE FOR CARRYING OUT THE INVENTION

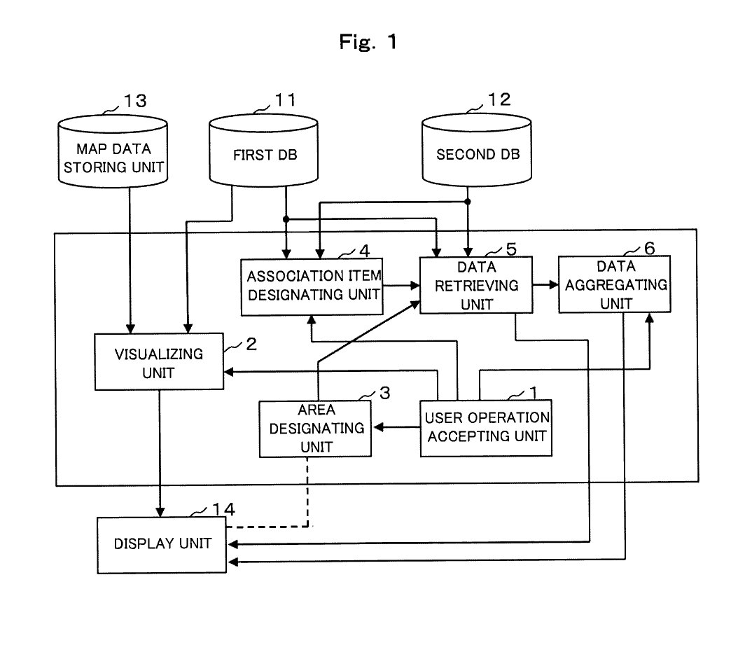

An embodiment of the present invention will be described below with reference to the drawings. FIG. 1 is a block diagram showing an example of a structure of a data processing system utilizing geographic information according to the present embodiment. As shown in FIG. 1, the data processing system according to the present embodiment includes a user operation accepting unit 1, a visualizing unit 2, an area designating unit 3, an association item designating unit 4, a data retrieving unit 5 and a data aggregating unit 6. Moreover, a first database 11, a second database 12, a map data storing unit 13 and a display unit 14 are connected to the data processing system according to the present embodiment.

Herein, each of the function blocks 1 to 6 can also be configured from all of hardware, a DSP (Digital Signal Processor) and software. For example, in the case in which each of the function blocks 1 to 6 is configured from the software, it actually includes a CPU, an RAM, an ROM and the like in a computer and is implemented by an operation of a program stored in a recording medium such as the RAM, the ROM, a hard disk or a semiconductor memory.

The first database 11 represents a database having geographic information as a data item. The geographic information represents information such as an address or a latitude and longitude. In addition, the geographic information may be coordinate information capable of specifying a position on a map. It is sufficient that the first database 11 has geographic information as one of the data items and the other data items are optional. The first database 11 has a plurality of data sets (records), each of which is configured from data of the data items including the geographic information.

The second database 12 is different from the first database 11 and it is not essential that the second database includes the geographic information as the data item. However, it is preferable that the second database 12 should be a database including at least one of the same data items as those of the first database 11 or a database including at least one of the data items capable of containing data which are partially coincident with data stored in a certain one of the data items of the first database 11. The second database 12 also has a plurality of data sets (records), each of which is configured from data of the data items.

For example, it is assumed that the first database 11 is a client management database including an “address” and a “company name” of a client and the like as the data item. On the other hand, it is assumed that the second database 12 is a sales management database including the same data items as the “company name” possessed as the data item by the first database 11. Thus, both the first database 11 and the second database 12 have the same data item of “company name”. Consequently, it is possible to retrieve and aggregate data by associating the first data base 11 with the second database 12 as will be described later.

Moreover, it is assumed that the first database 11 is a stock management database including an “address” and a “base name” of a base and the like as data items. On the other hand, it is assumed that the second database 12 is a sales management database including a “store name”, a “sales amount” and the like as the data items. Even though neither of the first database 11 and the second database 12 include the same data items, thus, the data can be retrieved and aggregated by association of the first database 11 and the second database 12 as will be described later if there is included any data item capable of storing data which might be coincident at least partially, for example, the “base name” and the “store name”.

The map data storing unit 13 stores map data for displaying a map on the display unit 14 configured from a liquid crystal display or the like. The map data includes coordinate information for specifying a position on the map.

The user operation accepting unit 1 accepts various user operations for the data processing system. For example, the user operation accepting unit 1 accepts a user operation related to zooming or scroll of the map displayed on the display unit 14. Moreover, the user operation accepting unit 1 accepts the user operation designating a desirable area on the map displayed on the display unit 14. Furthermore, the user operation accepting unit 1 accepts a user operation for associating an optional data item included in the first database 11 with an optional data item included in the second database 12. Furthermore, the user operation accepting unit 1 accepts a user operation for designating to aggregate, by a desirable method, data included in a data set retrieved from the second database 12 as will be described later.

The visualizing unit 2 visualizes and displays data included in the first database 11 or a result of calculation for the data on a map based on geographic information. In other words, the visualizing unit 2 displays the map on the display unit 14 based on map data stored in the map data storing unit 13. Herein, when the user operation accepting unit 1 accepts the user operation related to the zooming or scroll of the map, the visualizing unit 2 performs zooming or scroll processing over the map which is being displayed.

Moreover, the visualizing unit 2 extracts data sets including geographic information associated with an area of the map displayed on the display unit 14 from the data sets (records) stored in the first database 11 and displays, in relevant positions on the map, point marks corresponding to the number of the extracted data sets with a single data set as a single point mark, for example. The relevant position represents a coordinate position on the map indicated by the geographic information. If the geographic information is an address, the address is converted into map coordinates to specify a position by using the well-known technology referred to as geocoding.

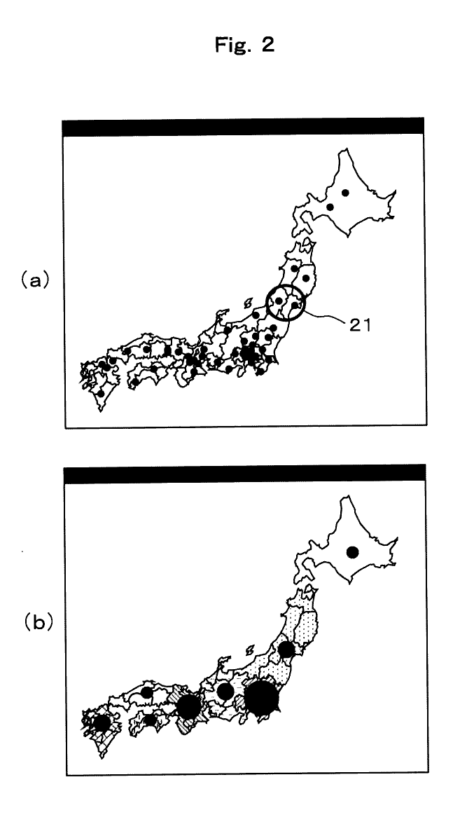

FIG. 2 is a view showing an example of a screen to be displayed by the visualizing unit 2. In the example of FIG. 2, a map of overall Japan is displayed. In the example of FIG. 2(a), there is shown a state in which a plurality of data sets storing addresses in Japan are extracted from the first database 11 and a plurality of point marks corresponding to each data set are displayed in relevant positions on the map, respectively.

The point marks are not displayed corresponding to the number of the data sets extracted from the first database 11 but a predetermined aggregation result can also be visualized on the map. In the example of FIG. 2(b), there is shown a state in which the map of Japan is divided into a plurality of areas, the number of the data sets extracted from the first database 11 is aggregated for each area and bubble marks representing results of the aggregation are displayed on each area.

The example shown in FIG. 2 is only one of specific processing examples of the visualizing unit 2 and the present invention is not restricted thereto. For example, it is also possible to aggregate, for each area, data of a predetermined data item included in the data set extracted from the first database 11 and to display a result of the aggregation by color classification for each area or in a graph.

The area designating unit 3 designates a desirable area on the map displayed on the display unit 14 by the visualizing unit 2 based on the user operation accepted by the user operation accepting unit 1. For example, the area designating unit 3 designates a desirable area 21 on the map in accordance with a mouse operation through a user as shown in FIG. 2(a). Although a circular region is designated as the desirable area 21 in FIG. 2, the present invention is not restricted thereto. For example, the desirable area may be a rectangular region. Alternatively, the desirable area may be a region surrounded by an optional polygonal line or curved line. Moreover, the desirable area may be an optional point clicked by a mouse.

As a further example, the area itself of the map displayed on the display unit 14 by the user operation related to the zooming or scroll as described above may be a designated area. Furthermore, a desirable area may be designated by selection of any of areas divided previously in accordance with administrative districts such as prefectures or municipalities.

The association item designating unit 4 designates an optional data item included in the first database 11 as an association source item and designates an optional data item included in the second database 12 as an association destination item based on the user operation accepted by the user operation accepting unit 1. Herein, it is preferable that the data item of the first database 11 to be designated as the association source item and the data item of the second database 12 to be designated as the association destination item should be data items which are identical to each other or data items which can include at least partially coincident data.

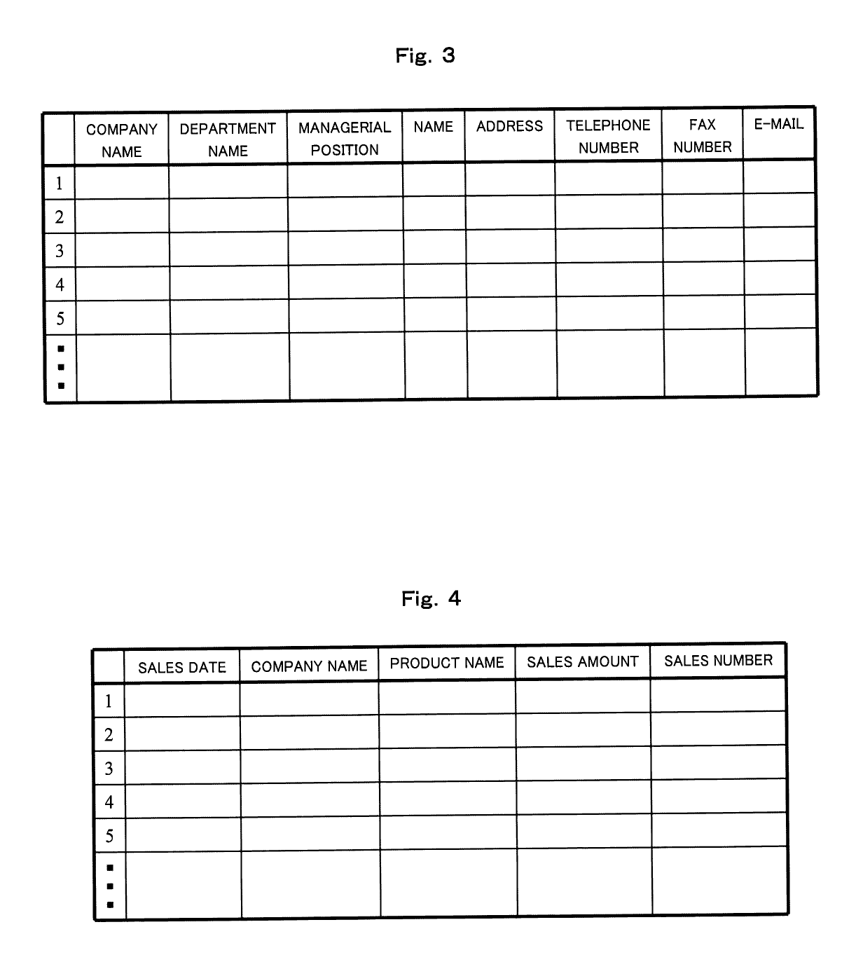

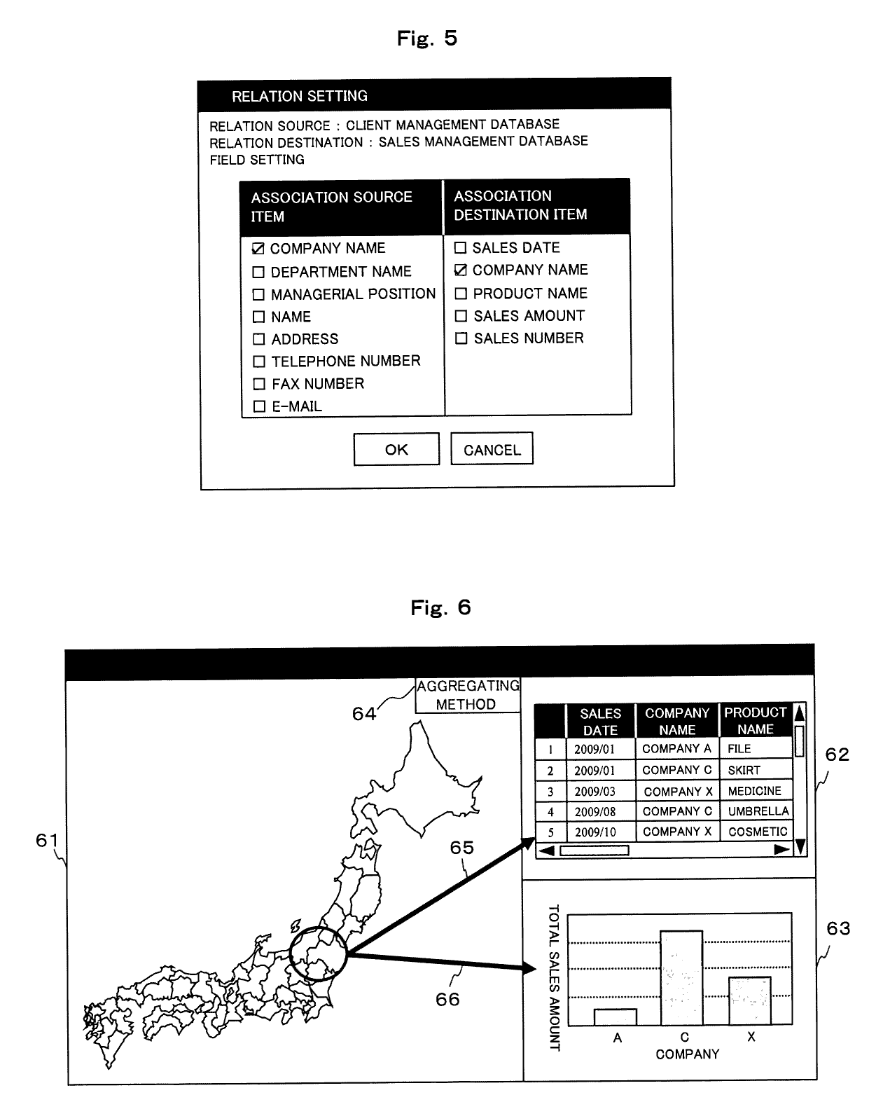

Association of the data items to be performed by the association item designating unit 4 will be described in detail with reference to FIGS. 3 to 5. Herein, FIG. 3 is a table showing an example of the first database 11. FIG. 4 is a table showing an example of the second database 12. FIG. 5 is a view showing an example of an operation screen for associating the data items (hereinafter referred to as a relation setting screen).

In the example shown in FIG. 3, the first database 11 is a client management database including, as the data items, a company name, a department name, a managerial position, a name, an address, a telephone number, a FAX number and an electronic mail of a client. In the example shown in FIG. 4, moreover, the second database 12 is a sales management database including, as the data items, a sales date of a product, a company name of a sales destination, a product name, a sales amount and a sales number. The first database 11 includes the data item of “address” as the geographic information. In contrast, the second database 12 does not include the geographic information as the data item.

In this case, the data items included in the first database 11 are displayed in a list as selection candidates for the association source items and the data items included in the second database 12 are displayed in a list as selection candidates for the association destination items over the relation setting screen as shown in FIG. 5. The user selects any of the data items from the selection candidates for the association source item to designate the association source item and selects any of the data items from the selection candidates for the association destination item to designate the association destination item. At this time, it is preferable that the data item of “company name” included in the first database 11 and the second database 12 in common should be designated as the association source item and the association destination item, respectively.

It is preferable that the data item capable of storing at least partial coincident data should be designated as the association source item and the association destination item respectively like “base name” of the first database 11 and “store name” of the second database 12 if the first database 11 is the stock management database, the second database 12 is the sales management database and there is no data item to be included in the first database 11 and the second database 12 in common as described above.

The data retrieving unit 5 first extracts, from the first database 11, the data of the data item designated as the association source item by the association item designating unit 4 in the data sets linked to the geographic information associated with the area designated by the area designating unit 3. Next, the data retrieving unit 5 retrieves the second database 12 with, as a target, the data item designated for the association destination item by the association item designating unit 4 using the extracted data as a retrieval key, and extracts data sets including the retrieval key in the data of the association destination item from the second database 12. Then, the data retrieving unit 5 displays, on the display unit 14, the data sets extracted from the second database 12.

For example, it is assumed that a desirable region of “Shibuya-ku, Tokyo” is designated by the area designating unit 3. Moreover, it is assumed that the data item of “company name” is designated as the association source item of the first database 11 and the data item of “company name” is designated as the association destination item of the second database 12.

In this case, the data retrieving unit 5 first performs retrieval with, as a target, the data item of “address” to be the geographic information of the first database 11 and extracts, from the first database 11, the data having the data item of “company name” in the data sets in which map coordinates corresponding to an address are included in the designated area of “Shibuya-ku, Tokyo”. Consequently, it is assumed that data on three company names of Company A, Company C and Company X are extracted, for example.

Next, the data retrieving unit 5 retrieves the second database 12 with, as a target, the data item of “company name” designated for the association destination item by using, for the retrieval key, the three data on the A, C and X companies extracted from the first database 11 as described above. Consequently, the data sets having the same name as any of the A, C and X companies serving as the retrieval key included in the data of “company name” (that is, the data sets having the company name which is partially coincident) are extracted from the second database 12. Then, the data retrieving unit 5 displays the data sets thus extracted from the second database 12 in a table format on the display unit 14, for example.

If execution of the aggregation by a desirable method is designated for the data sets retrieved by the data retrieving unit 5, the data aggregating unit 6 performs aggregation by a designated method with, as a target, the data sets extracted from the second database 12 through the data retrieving unit 5. Then, the data aggregating unit 6 displays a result of the aggregation on the display unit 14. As an example of the aggregation, data values of the data item designated from the data sets extracted from the second database 12 are summed up, a mean value is calculated, a ratio to a whole is calculated, ranking is performed, and the like. The contents of the aggregation given herein are only illustrative and the present invention is not restricted thereto.

FIG. 6 is a view showing an example of a screen to be offered by the data processing system utilizing the geographic information according to the present embodiment. The screen shown in FIG. 6 has a map display region 61 for displaying a map image to be generated from data of the first database 11 and map data of the map data storing unit 13 by the visualizing unit 2, a retrieval result display region 62 for displaying data sets retrieved from the second database 12 by the data retrieving unit 5 and an aggregation result display region 63 for displaying a result of aggregation performed for the data sets by the data aggregating unit 6.

For example, when a desirable area is designated by operating a mouse in the map display region 61 and the mouse is then subjected to a drag operation from the map display region 61 to the retrieval result display region 62, an arrow 65 from the map display region 61 toward the retrieval result display region 62 is drawn and the relation setting screen shown in FIG. 5 is pop-up displayed. When a user designates an association source item and an association destination item over the relation setting screen, data retrieval is performed by the data retrieving unit 5. Thereafter, the data sets thus extracted from the second database 12 are displayed in a table format on the retrieval result display region 62 as shown in FIG. 6.

When a desirable area is designated by operating the mouse in the map display region 61 and the mouse is then subjected to the drag operation from the map display region 61 to the aggregation result display region 63, moreover, an arrow 66 from the map display region 61 toward the aggregation result display region 63 is drawn and the relation setting screen shown in FIG. 5 is pop-up displayed. When the user designates the association source item and the association destination item over the relation setting screen and designates a desirable aggregating method over another screen, the data retrieval is performed by the data retrieving unit 5. Furthermore, aggregation is performed, by the data aggregating unit 6, for the data sets thus extracted from the second database 12. A result of the aggregation thus obtained is displayed on the aggregation result display region 63 as shown in FIG. 6.

In the example of FIG. 6, an aggregating method setting button 64 is displayed on a right and upper part of the map display region 61. When the user presses the aggregating method setting button 64 down through the mouse, a predetermined aggregating method setting screen (not shown) is pop-up displayed. The user can designate an aggregating method (a total value, a mean value, a ratio, ranking or the like) indicative of how to perform aggregation and which one of data items included in the second database 12 is subjected to data aggregation through the aggregating method setting screen. Moreover, it is also possible to designate which format is used to display the aggregation result. For example, it is possible to designate which is used to display the aggregation result, a table format or a graph format, which graph type is used and which data item is set to be an axis when the display is to be performed in the graph format, and the like.

The aggregation result display region 63 in FIG. 6 shows a state in which total values of sales amounts for each company are aggregated and a result of the aggregation is displayed in a bar graph with, as a target, the data sets retrieved from the second database 12 by the data retrieving unit 5 (the data sets storing any of the companies A, C and X as the company name in the second database 12).

As described above in detail, in the present embodiment, a desirable area on a map is designated in a state in which data included in the first database 11 or a result of calculation for the data is visualized and displayed on the map. Then, an optional data item included in the first database 11 is designated as an association source item and an optional data item included in the second database 12 is designated as an association destination item.

When the designation is thus performed, the data retrieving unit 5 extracts, from the first database 11, data of the data item designated as the association source item in the data sets linked to the geographic information associated with the designated area. Furthermore, the data retrieving unit 5 retrieves the second database 12 with, as a target, the data item designated as the association destination item by using the extracted data for a retrieval key, and extracts data sets having the retrieval key included in the data of the association destination item from the second data base 12 and displays the data sets on the display unit 14. In the case in which it is designated that the aggregation is performed by a desirable method, moreover, the data aggregating unit 6 performs the aggregation by a designated method with, as a target, the data sets extracted from the second database 12 as described above and displays a result of the aggregation on the display unit 14.

According to the data processing system in accordance with the present embodiment having such a structure, the data associated with the area designated on the map is extracted from the first database 11 by utilizing the geographic information included in the first database 11, and furthermore, the second database 12 is retrieved with the extracted data as the retrieval key so that data sets corresponding to a condition of the retrieval key are extracted.

According to the present embodiment, thus, it is possible to retrieve and aggregate data included in the second database 12 beyond the range of the data included in the first database 11 by utilizing the geographic information possessed by the first database 11. Herein, the second database 12 is retrieved with, as the retrieval key, the data extracted from the first database 11. For this reason, it is not essential that the geographic information is included as the data item in the second database 12.

From the foregoing, according to the present embodiment, it is possible to flexibly retrieve and aggregate data utilizing the geographic information beyond a range of data included in a single database. According to the present embodiment, moreover, it is also possible to retrieve and aggregate the data associated with the area designated on the map for also a database having no geographic information as the data item.

Although the sales management database including no geographic information as shown in FIG. 4 has been described as an example of the second database 12 in the embodiment, the present invention is not restricted thereto. In other words, it is apparent that the database having the geographic information can be used as the second database 12.

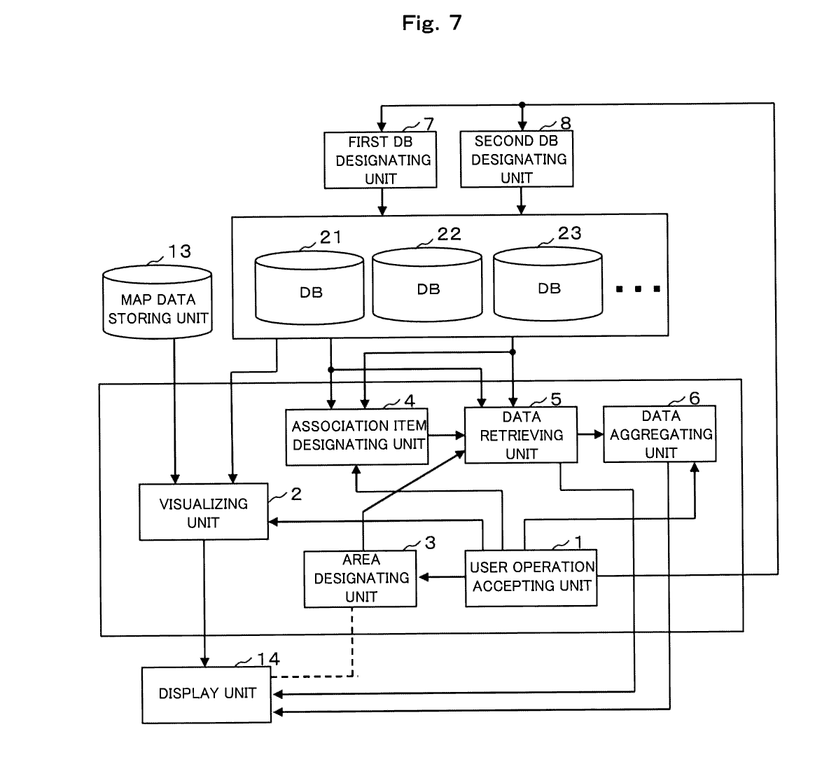

Although the description has been given to the example in which only two databases are provided, and one of them is set to be the database 11 and the other is set to be the second database 12 in the embodiment, moreover, the present invention is not restricted thereto. For example, as shown in FIG. 7, three or more databases 21, 21, 23, . . . may be provided to enable designation of an optional one of them (including the geographic information) as the first database 11 by the first database designating unit 7 based on the user operation to be accepted by the user operation accepting unit 1.

Similarly, it is also possible to designate an optional one of the databases (the geographic information may be or may not be included) as the second database 12 by the second database designating unit 8 based on the user operation to be accepted by the user operation accepting unit 1. Moreover, two or more optional ones of the databases may be designated as the second database 12. In the case in which a plurality of databases are designated as the second database 12, a plurality of the retrieval result display regions 62 and a plurality of the aggregation result display regions 63 are also displayed on the screen. For example, in the case in which two databases are designated as the second database 12, a single retrieval result display region 62 and a single aggregation result display region 63 are provided on each of left and right of the map display region 61.

Although the description has been given to the example in which the retrieval result display region 62 and the aggregation result display region 63 are prepared separately as shown in FIG. 6 in the embodiment, moreover, the present invention is not restricted thereto. For example, the display of only one of the retrieval result and the aggregation result may be enabled, and only the retrieval result display region 62 may be displayed when it is designated to display the retrieval result by the user operation, while only the aggregation result display region 63 may be displayed when it is designated to display the aggregation result by the user operation.

In addition, the embodiment is only illustrative for concreteness in the execution of the present invention and the technical scope of the present invention should not be thereby construed to be restrictive. In other words, the present invention can be carried out in various configurations without departing from the gist or main features thereof.

### EXPLANATION OF DESIGNATION

1 user operation accepting unit

2 visualizing unit

3 area designating unit

4 association item designating unit

5 data retrieving unit

6 data aggregating unit

7 first database designating unit

8 second database designating unit

11 first database

12 second database

13 map data storing unit

1. A data processing system utilizing geographic information comprising:
a visualizing unit for visualizing and displaying data included in a first database having geographic information as a data item or a calculation result for the data on a map based on the geographic information;
an area designating unit for designating a desirable area on the map based on a user operation;
an association item designating unit for designating an optional data item included in the first database as an association source item and designating, as an association destination item, an optional data item included in a second database which is different from the first database based on the user operation; and
a data retrieving unit for extracting, from the first database, data of the data item designated as the association source item by the association item designating unit in data sets linked to geographic information associated with the area designated by the area designating unit, retrieving the second database with, as a target, the data item designated as the association destination item through the association item designating unit by using the extracted data as a retrieval key, and extracting data sets including the retrieval key in data of the association destination item from the second database.

2. The data processing system utilizing geographic information according to claim 1 further comprising a data aggregating unit for performing aggregation by a designated method with, as a target, the data sets extracted from the second database by the data retrieving unit.

3. The data processing system utilizing geographic information according to claim 1, wherein the second database is a database having no geographic information as a data item.

4. The data processing system utilizing geographic information according to claim 1 further comprising a first database designating unit for designating the first database based on a user operation.

5. The data processing system utilizing geographic information according to claim 4 further comprising a second database designating unit for designating the second database based on a user operation.

6. A data processing program utilizing geographic information for causing a computer to function as:
visualizing means for visualizing and displaying data included in a first database having geographic information as a data item or a calculation result for the data on a map based on the geographic information;
area designating means for designating a desirable area on the map based on a user operation;
association item designating means for designating an optional data item included in the first database as an association source item and designating, as an association designation item, an optional data item included in a second database which is different from the first database based on the user operation; and
data retrieving means for extracting, from the first database, data of the data item designated as the association source item by the association item designating means in data sets linked to geographic information associated with the area designated by the area designating means, retrieving the second database with, as a target, the data item designated as the association destination item through the association item designating means by using the extracted data as a retrieval key, and extracting data sets including the retrieval key in data of the association destination item from the second database.

7. The data processing program utilizing geographic information according to claim 6 for causing the computer to further function as data aggregating means for performing aggregation by a designated method with, as a target, data sets extracted from the second database by the data retrieving means.

8. The data processing system utilizing geographic information according to claim 2, wherein the second database is a database having no geographic information as a data item.

9. The data processing system utilizing geographic information according to claim 8 further comprising a first database designating unit for designating the first database based on a user operation.

10. The data processing system utilizing geographic information according to claim 2 further comprising a first database designating unit for designating the first database based on a user operation.

11. The data processing system utilizing geographic information according to claim 3 further comprising a first database designating unit for designating the first database based on a user operation.

12. The data processing system utilizing geographic information according to claim 11 further comprising a second database designating unit for designating the second database based on a user operation.

13. The data processing system utilizing geographic information according to claim 1 further comprising a second database designating unit for designating the second database based on a user operation.

14. The data processing system utilizing geographic information according to claim 2 further comprising a second database designating unit for designating the second database based on a user operation.

15. The data processing system utilizing geographic information according to claim 3 further comprising a second database designating unit for designating the second database based on a user operation.

16. The data processing system utilizing geographic information according to claim 8 further comprising a second database designating unit for designating the second database based on a user operation.

17. The data processing system utilizing geographic information according to claim 9 further comprising a second database designating unit for designating the second database based on a user operation.

18. The data processing system utilizing geographic information according to claim 10 further comprising a second database designating unit for designating the second database based on a user operation.
